(19) United States
(12) Patent Application Publication
(10) Pub. No.: US 2009/0113750 A1
(43) Pub. Date: May 7, 2009

(54) Washer/Dryer

(75) Inventors: Mehmet Ozbek, Istanbul (TR); Serap Dikmenli, Istanbul (TR)

Correspondence Address: VENABLE, CAMPILLO, LOGAN & MEANEY, P.C., 1938 E. OSBORN RD, PHOENIX, AZ, 85016-7234, US

(73) Assignee: ARCELIK ANONIM SIRKETI, Istanbul (TR)

(21) Appl. No.: 11/568,764

(22) PCT Filed: Apr. 19, 2005
(86) PCT No.: PCT/IB05/51276

§ 371 Date: Nov. 6, 2006

(30) Foreign Application Priority Data
Apr. 28, 2004 (TR) 2004/00900

(51) Int. Cl. F26B 3/34

(52) U.S. Cl. 34/261

(57) ABSTRACT

This invention relates to a washer/dryer (1) in-corporating a connection which prevents the microwave energy routed to the interior of the tub (2) from leaking to the outside of the tub (2), and also allows the fluids to pass without being choked.

This invention relates to a washer/dryer comprising a tub which, in mediums where microwave energy is utilized, prevents the leakage of the microwave that is routed to the interior of it, without blocking the passage of the fluids used during the washing process.

Mediums, where microwave energy is utilized, are coated with microwave proof materials in order not to affect the living entities around. In washer/dryers, the mentioned function is carried out by the metal tubs where the laundry is placed into. However, problems may arise concerning the microwave proofing at the apertures on the tubs whereby the cleaning material and water are transferred into and discharged out of the tubs. If leak proofing can not be achieved, the living in the environment where the device is operated and some parts of the washer/dryer such as plastic parts at the inlet and outlet of the tub, are negatively affected by the microwave energy. For that reason, at the inlet and outlets where the apertures which may cause a leakage of microwave energy are placed, projections and conduits should be utilized which are made of a material that is not affected by the microwave energy such as metal and have a depth-width ratio determined with respect to the wave length of the microwave energy, providing the microwave proofing. However, projections and conduits take up so much space that problems may occur concerning the design and use.

In washers/dryers, the microwave energy utilized may be at different frequencies such as 915 MHz and 2450 MHz. In order to achieve microwave proofing at the used frequency, the apertures on the tub should not be larger than the dimensions determined according to the experimental data. If the said dimensions are exceeded, even if projections with a depth-width ratio determined with respect to the wavelength of the microwave energy are utilized, microwave energy leaks outside the medium. As for the dimensions of the apertures that are less than the afore-mentioned dimensions, it is necessary to use protection surfaces made of microwave proof materials, having forms and dimensions with a depth-width ratio determined with respect to the wave length of the applied microwave energy and aperture dimensions.

The aim of the present invention is the realization of a washer/dryer comprising an aperture which prevents that the microwave energy that is routed to the interior of the tub from leaking to the outside of the tub and, enables the passage of the fluids without being choked.

The washer/dryer designed to fulfill the objectives of the present invention is illustrated in the attached figures where:

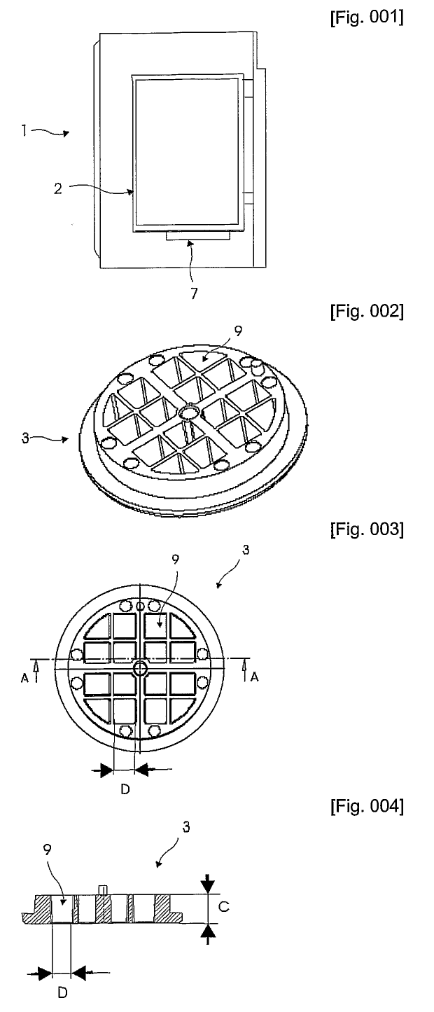

FIG. 1—is a schematic representation of a washer/dryer.

FIG. 2—is a perspective view of a grid.

FIG. 3—is a top view of a grid.

FIG. 4—is a sectional view of a grid, taken from A-A.

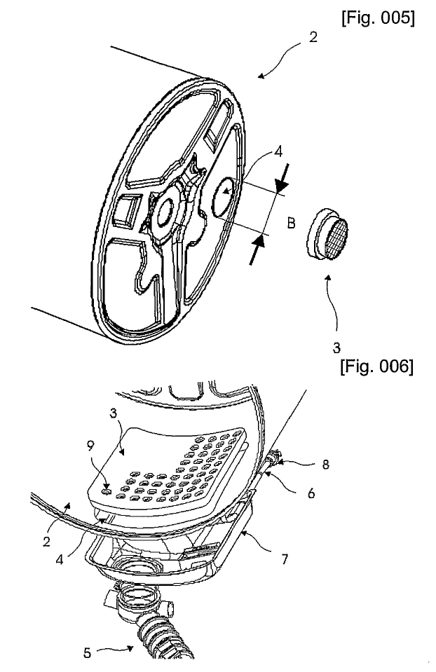

FIG. 5—is a perspective view of a grid, a tub and an aperture on the tub.

FIG. 6—is a perspective view of a grid, a tub and a heater pocket.

Elements shown in figures are numbered as follows:
1. Washer/dryer
2. Tub
3. Grid
4. Aperture
5. Conduit
6. Heater
7. Heater pocket
8. Fastener
9. Hole

The washer/dryer (1) comprises a tub (2) wherein laundry washing/drying process is performed, one or more than one aperture (4) positioned on the tub (2), whereby the cleaning materials and water are taken into and discharged out of the tub (2), one or more than one conduit (5), for instance a flexible hose, connected to the aperture (4) and a grid (3) having geometric dimensions and forms so that microwave proofing is achieved; this grid (3) is positioned onto the aperture (4) or between the aperture (4) and the conduit (5) and manufactured from a microwave proof material.

The grid (3) comprises more than one hole (9) with such depth (C) and width (D) dimensions that ensure the depth-width ratio necessary to achieve the microwave proofing, at the wavelength of the applied microwave energy.

While microwave energy proofing depth necessary for the aperture (4) is reduced by increasing the number of the holes (9) and by decreasing the hole (9) width (D), it is also important that the hole (9) width (D) should be so wide as not to obstruct the passage of the water, cleaning material and such particles inside the washing chamber as fiber and pile, which are discharged and taken in therethrough. Otherwise, the hole (9) gets choked and blocks the flow that passes therethrough, namely the taking in and discharge of such matter as the water or the cleaning material to and out of the tub (2). Therefore, the hole (9) depth (C) determined in relation to the geometric limits of the location of use and the hole (9) width (D) determined in relation to the flow at the location of use, are optimized so that the hole (9) does not obstruct the flow that passes therethrough. Thus, while achieving microwave proofing, it is also accomplished that the grid (3) used is with desired dimensions and at the desired location and moreover, does not obstruct the flow.

In another embodiment of the present invention, the tub (2) comprises a heater (6) which heats the washing water inside, a heater pocket (7) positioned on it, where the heater (6) is placed into and, one or more than one fastener (8) whereby the heater (6) is attached to the interior of the heater pocket (7). In the mentioned embodiment, in order for the heater (6) and the fastener (8) to be able to function without being affected by the applied microwave energy, a grid (3) is utilized which comprises more than one hole (9) and is positioned to the aperture (4) on the tub (2); this aperture (4) is wide enough to cover the heater pocket (7).

In another embodiment of the present invention, the tub (2) and the grid (3) are manufactured in a single piece, as integrated. In the said embodiment, the tub (2) is provided with holes (9) so as to cover the aperture on it, wherein the said holes (9) are bored to have a depth (C) and width (D) suitable for the depth-width ratio, which is determined by the wavelength of the applied microwave energy.

By the application of to the present invention, in a washer/dryer (1), microwave proofing and also continuity of the flow inside are ensured by means of a grid (3) utilized in a space appropriate for the width (B) of an aperture (4); this grid (3) having a depth (C) less than the necessary depth for the width of the aperture (4) to achieve microwave proofing.

1. A washer/dryer (1) comprising a tub (2) wherein laundry washing/drying process is performed, one or more than one aperture (4) positioned on the tub (2), whereby the cleaning materials and water are taken into and discharged out of the tub (2), one or more than one conduit (5) connected to the aperture (4) and characterized by a grid (3) with geometric dimensions and forms so that microwave proofing is achieved, positioned onto the aperture (4) or between the aperture (4) and the conduit (5), manufactured from a microwave proof material and, comprises more than one hole (9) with such depth (C) and width (D) dimensions that ensure the depth-width ratio necessary to achieve the microwave proofing, at the wave length of the applied microwave energy.

2. A washer/dryer (1) as described in claim 1, characterized by a tub (2) which is manufactured in a single piece with the grid (3), as integrated.

3. A washer/dryer (1) as described in claim 1 or 2, characterized by a tub (2) which comprises a heater (6) that heats the washing water inside, a heater pocket (7) positioned on it, where the heater (6) is placed into and, one or more than one fastener (8) whereby the heater (6) is attached to the interior of the heater pocket (7), and by a grid (3) providing microwave proof and, positioned to the aperture (4) on the tub (2) being utilized in order for the heater (6) and the fastener (8) to be able to function without being affected by the applied microwave energy; this aperture (4) is wide enough to cover the heater pocket (7) .
